(19) United States
(12) Patent Application Publication
(10) Pub. No.: US 2024/0245941 A1
(43) Pub. Date: Jul. 25, 2024

(54) PROTECTIVE HOOD ASSEMBLY

(71) Applicant: TB-Safety AG, Frick (CH)

(72) Inventors: Nik KEEL, Kuettigen (CH); Rudolf HEIMERL, Untermeitingen (DE)

(73) Assignee: TB-Safety AG, Frick (CH)

(21) Appl. No.: 18/564,147

(22) PCT Filed: May 19, 2022
(86) PCT No.: PCT/EP2022/063665

§ 371 Date: Nov. 27, 2023

(30) Foreign Application Priority Data
May 28, 2021 (AT) A 50428/2021

(51) Int. Cl. A62B 18/04; A62B 17/04; A62B 18/08; A62B 23/02

(52) U.S. Cl. CPC A62B 18/045; A62B 17/04; A62B 18/08; A62B 18/084; A62B 23/02

(57) ABSTRACT

A protective hood assembly includes a protective hood which covers the user's head and shoulders and an active air exchange system with a fan, a housing for the fan and a filter in the protective hood for used air. The protective hood and the fan are equipped for the arrangement of the fan within the protective hood.

### CROSS REFERENCE TO RELATED APPLICATIONS

This application is the National Stage of PCT/EP2022/063665 filed on May 19, 2022, which claims priority under 35 U.S.C. § 119 of Austrian Application No. A 50428/2021 filed on May 28, 2021, the disclosure of which is incorporated by reference. The international application under PCT article 21(2) was not published in English.

### BACKGROUND OF THE INVENTION

### 1. Field of the Invention

The invention relates to a protective hood assembly.

### 2. Description of the Related Art

Employees in aseptic cleanrooms or medical intensive care units have to wear suits and hoods, cleanroom masks, respiratory masks, and protective goggles—collectively referred to as “personal protective equipment” (PPE) or cleanroom clothing—to prevent contaminations. Problems regarding comfort, cooling and steaming up of glasses, for instance, frequently occur. An additional risk in the case of not completely closed head protection is a bidirectional infection risk. This is of particular importance in dealing with Covid-19, where both the protection of the PPE or cleanroom clothing user as well as their environment against possible infection by the PPE or cleanroom clothing user have to be ensured. Conventional protective equipment cannot ensure this, or only with great effort, meaning that widespread use of such personal equipment is hardly viable given the high costs.

EP 0468188 A1 discloses a protective hood assembly with a flexible protective hood with viewing window which covers the user's head and shoulders and is stretched over a mounting structure. An active air exchange system is provided with a fan each for inhaled air and exhaled air, each including housing and a filter integrated permanently in the protective hood. Both fans are arranged entirely with their housings within the protective hood, wherein the fan for the exhaled air is positioned in the neck area, whilst the fan for the inhaled air is located in the rear crown portion of the protective hood. The protective hood completely covers the fan, wherein filters are incorporated into the protective hood in the area of the air inlet and outlet openings. Similarly, WO 2014/160149 A2 discloses a protective hood assembly in which a flexible protective hood with viewing window is stretched over a mounting structure, and which covers the user's head and shoulders. An airflow into the inside of the protective hood can be effected by means of a ventilation assembly. The ventilation assembly is thereby positioned entirely beneath the protective hood, extending in the crown area up to the forehead area, and is completely covered by it. A filter area is incorporated in the protective hood in the suction opening area with inlet mesh. In an almost identical manner, WO 2009/079292 A1 discloses a completely covered fan and covering filtering within the protective hood.

WO 2008/106135 A1 discloses a surgical helmet covering assembly which seeks to protect the wearer from contaminations occurring during operations. It consists of a hood made of flexible material with transparent face protection which is pulled over a surgical helmet. A hood air inlet in the rear crown area and a hood air outlet in the neck area are provided in the hood which enable air exchange beneath the hood. The helmet can be provided with a fan assembly which is activated via a reclosable control opening.

U.S. Pat. No. 5,711,033 A also discloses a protective hood assembly with an airflow and filtration control system. A fan is mounted in a relatively rigid, open head holding structure. The fan is positioned such as to move air through the channels formed in the head covering structure. A cover (or hood) with viewing window is placed over the head covering structure and attached to it such that is completely covers the head covering structure and at least part of the wearer. Filtration areas are incorporated in the cover, or it is fashioned entirely of filtration material. The filtration areas are thereby preferably arranged adjacent to the fans when the cover is arranged over the head holding structure. A power supply assembly supplies the power for operating the fans.

GB 2399759 A discloses a rigid helmet with integrated air supply to protect the user against mechanical impacts. A fan with an upstream filter which can be mounted on the air inlet ports of the helmet is integrated permanently in the helmet.

EP 3399881 B1 teaches a protective hood assembly with a flexible protective hood with viewing window, the hood consisting of a filter material and being stretched over a mounting structure. A housing for a fan for the inhaled air is integrated in the mounting structure and occupies an area from the apex of the assembly extending over the user's forehead. The microclimate inside the protective hood and/or the user's activity is/are detected via a sensor assembly, wherein dependent thereon the speed of the fan and thus the air flow is controlled.

Finally, WO 2005/061076 A1 discloses a self-closing filter connection for a gas mask to prevent contamination of the mask interior during filter exchange and thus to increase safety. A valve preloaded in the closing direction closes the connection if no filter is connected. As soon as a new filter has been inserted, the valve is thereby put into its open position so that air can again flow through the connection.

### SUMMARY OF THE INVENTION

The object of the present invention was to overcome the disadvantages of the prior art and provide an apparatus in which by means of a simple, modular assembly which is flexibly adaptable to various areas of application both areas on both sides of the contamination barrier or the system itself are protected from contamination, and in which the user of the apparatus is supplied as well as possible and safely with breathing air by a highly comfortable and safe assembly.

The invention relates to a protective hood assembly, comprising a protective hood which covers the user's head and shoulders made from flexible, pliable material and with a viewing window, a mounting structure for the protective hood, an active air exchange system with a fan, a housing for the fan arranged within and separate from the protective hood which is attached to the mounting structure within the protective hood, and a filter for the used air integrated in the protective hood.

To solve this problem, this protective hood assembly is characterized by at least one air inlet opening in the protective hood which leads to the fan and allows unimpeded passage, and by an inlet port for inhaled air emanating from the housing which is fed through the outer side of the air inlet opening of the protective hood in a sealed manner and which forms a releasable connection between the mounting structure and the protective hood. Wherein the air inlet opening and/or the inlet port is/are covered by a cleanroom fabric or filter fleece, preferably by a material of the FFP2 protection class, or by a breathing air filter placed on the inlet port in front of the filter on the outside of the protective hood, or by a mesh cover. The unimpeded permeability relates to the breathing air for the user of the assembly. Due to the configuration of the protective hood with the permeable air inlet opening, it can be used for a wide range of applications where the opening can remain open, e.g. in cleanrooms, because it is hereby guaranteed that no hazardous material whatsoever can enter the inside of the protective hood and only the room atmosphere is to be protected from the impurities originating from the user. Furthermore, the correct reciprocal positioning of the protective hood and the housing with fan can thus be simply and swiftly attained and ensured, which guarantees safe and unobstructed use of the assembly. The placement of a breathing air filter directly on the protective hood is thereby also possible without requiring long breathing air tubes which would increase the volume to be discharged.

For use in cleanrooms, purely for the mechanical protection of the fan, a mesh cover is preferably provided to cover the air inlet opening and/or the inlet port of the fan. In other uses with contaminated external atmospheres, the opening and/or inlet port are covered by a cleanroom fabric or filter fleece, preferably by an FFP2 protection class material, or by a breathing air filter for fresh air placed on the inlet port on the outside of the protective hood in front of the fan. Thus, only the easily exchangeable breathing air filter is arranged on the contaminated outer side of the protective hood, whilst all other parts of the system are arranged within the protective hood and protected against contamination. Should the user of the protective hood pose a risk of infection, the hood can simply be disposed of in its entirety.

According to an advantageous embodiment of the invention, the housing is arranged on the inside in the area between the crown and the front side of the protective hood. It is preferable in this case for the housing to also be fastened at that point, because mounting facilities are usually present there which can be used for this purpose. Preferably, the housing is fastened on the front side of the mounting structure for the protective hood assembly, because the viewing window is typically held on a head strap or head frame in this area, which can also take the weight of the housing and fan. Naturally, this also comprises all components and aggregates as are directly connected with the housing and the fan, such as the drive for the fan, a control circuit board, a directly connected power supply, etc.

Preferably, the inlet port passes through an upper section of the viewing window which is covered by the protective hood, and the breathing air filter is preferably arranged above the visible or transparent area of the viewing window.

Another embodiment of the assembly according to the invention provides for the housing of the fan and the inlet port to be arranged on the rear side of the protective hood. The housing thus does not impede the inclination of the protective hood user's head and the weight of the housing and fan does not have to be carried with every head movement. It is particularly advantageous in this regard for the housing to be arranged at the height of a neck section of the protective hood. It is thereby advantageous for the air inlet opening and, where present, a breathing air filter to also be arranged in the neck section of the protective hood.

The weight distribution and the bearing of the weight of the fan and housing by the user of the protective hood can be adjusted particularly well if a mounting frame or an assembly with at least one carrying strap beneath the protective hood is usable and releasably connectable with the housing. Alternatively, the housing can also be releasably connectable with the mounting structure.

A further embodiment of the invention provides for a helmet positioned within the protective hood, onto which the mounting structure for the housing or the housing itself with its fan and the power supply, and preferably of course also the protective hood itself with the viewing window, are assembled. The user is thereby protected against mechanical impacts as can occur when using the assembly in industrial settings.

A further embodiment of the invention provides for the housing to be arranged with at least one discharge opening directed into the inside of the protective hood for fresh air. This feature also contributes to avoiding unnecessarily long air pipes which increase the effort for decontamination or for the volume to be discharged. Preferably, the discharge opening is directed towards the front side of the protective hood and/or towards the viewing window to guide the fresh air as directly to the user's mouth and nose as possible and at the same time also prevent the viewing window from steaming up. A further advantage of an airflow passing through this discharge opening and being directed at and concentrated on the protective hood assembly user's mouth-nose area is the guiding away of the exhaled, carbon dioxide imbued air. A CO₂ concentration of lower than 1 vol. % can thereby be achieved for the air available for inhalation.

Advantageously, with a view to simplifying the construction and the compactness of the assembly, it can further be provided that the drive of the fan is integrated in its housing. An embodiment is thereby preferred in which a self-sufficient power supply unit can be coupled with the housing.

According to an advantageous embodiment of the invention, the power supply unit is positioned at a distance from the housing on the inner side of the protective hood. The weight distribution of the assembly can thereby be improved. Preferably, the power supply unit is attached to a carrying strap or browband, and preferably on the rear side opposite the viewing window, thus allowing the considerable weight of the power unit to be more comfortably born by the user. According to a particularly preferred embodiment, the power supply unit is connected with the drive and the control assembly for the fan via a preferably flexible electricity and control line.

Another embodiment of the invention is, however, characterized in that the housing has a receptacle for the self-sufficient power supply unit which can be directly coupled with the housing. The power supply unit can preferably be inserted into the housing. The receptacle is preferably positioned in the area of the front side of the mounting structure for the protective hood assembly and/or in the longitudinal central plane of the mounting structure because the weight distribution of the fan and the power supply unit is optimally adjusted to the mounting frame there, which can bear the weight of the housing and the fan as well as the power supply unit in an even and balanced manner.

As a preferable further feature of the invention, it is provided that at least a partial area of the protective hood consists of a filter fleece which constitutes the filter for the used air, wherein the partial area is preferably arranged on the rear side of the protective hood. Preferably, a material of at least the FFP2 protection class is provided for. According to this embodiment, the majority of the protective hood is fashioned from a material which is impervious to solid or fluid aerosols with negligible volatility and decomposition, and against germs and viruses.

Where necessary, the entire protective hood can consist of a filter fleece, preferably also of a material of at least the FFP2 protection class. Fashioning the protective hood from a cleanroom fabric is also possible if use is to be exclusively in aseptic cleanrooms.

It is thereby advantageous if according to a further feature of the invention the fan is connected with a control assembly which initiates operation of the fan after insertion of the breathing air filter. For use in cleanrooms where breathing air filters are not necessary, the fan can also be activated by inserting a mesh cover, for instance.

Another aspect of the invention is an improved control assembly for the protective hood assembly according to one of the preceding paragraphs.

In order to not only ensure comfort and flexible use for the user of the apparatus but also supply them with breathing air in as good and safe a manner as possible, even if the user's exposure and thus their oxygen requirements rapidly and/or severely change, a control assembly is suggested characterized by a sensor unit which emits at least a signal representing the user's breathing rate, an evaluation unit with at least one input for the signal of the sensor unit and an output for a control signal for the fan, and a control unit for the fan with an input for the control signal of the evaluation unit, wherein the evaluation unit is configured to generate a control signal for the fan which is proportional to the breathing rate, in such a way that the quantity of air propelled by means of the fan is proportional to the breathing rate. An increasing CO₂ concentration in the air within the protective equipment at increased breathing rate can be compensated by an increase in the airflow and be maintained below a level which would be dangerous for the user.

The air quantity is preferably within a range of between 40 l/m and 100 l/min and the fan is preferably configured such that it is precisely adjustable up to the two limits, but can also ensure higher loads when propelling air quantities in the upper limit range for longer periods without overloading.

A simple and reliable detection of breathing rate can be performed by means of pressure monitoring inside the protective clothing, in particular in the protective hood or other areas near to the user's mouth and nose, for which according to a further embodiment of the invention the sensor unit has a pressure sensor for the air within the protective hood.

A further embodiment of a control assembly according to the invention provides that the sensor unit has a CO₂ sensor and that the evaluation unit is configured such that if a threshold value for the CO₂ concentration within the protective hood is exceeded, the fan is sped up and/or a warning signal is generated. A safety function is thus implemented in case the rapid adjustment adapted to the user's breathing rate via pressure or breathing rate should fail or be disrupted.

In order to avoid overloading the control circuit for the fan and thus reduce the load of the fan, the evaluation unit is preferably configured such that the control signal for the fan is only generated after a predeterminable number of shortened or extended breathing cycles.

According to a preferred embodiment, a further safety level is provided in that a safety algorithm is implemented in the unit which initiates at least a predeterminable action in the event of a non-detectable and/or absent pressure change, and in particular initiates a warning signal and/or switches the fan to a safety mode.

Preferably, the safety algorithm is configured such that in the safety mode the fan is controlled to propel an air quantity of 80 l/min.

### BRIEF DESCRIPTION OF THE DRAWINGS

Further features and advantages of the invention can be derived from the following description which refers to the enclosed figures.

For a better understanding of the invention, it is explained in more detail with reference to the following figures.

These show in significantly simplified, schematic representation:

FIG. 1 a schematic view of a first embodiment of a protective hood assembly according to the invention in an inclined front view;

FIG. 2 the protective hood assembly according to FIG. 1 without the actual protective hood, in an inclined view from above;

FIG. 3 the arrangement according to FIG. 2 directly from the front;

FIG. 4 a vertical section along the IV-IV line of FIG. 3 through the housing, the fan and the breathing air filter according to FIG. 2;

FIG. 5 a horizontal section along the V-V line of FIG. 3 through the housing, the fan and the breathing air filter according to FIG. 2;

FIG. 6 a further enlarged view of the area of the housing with the filter detection assembly;

FIG. 7 an exploded view of the assembly according to FIG. 2;

FIG. 8 the circuit board for the filter detection of the protective hood assembly;

FIG. 9 a schematic view of a second embodiment of a protective hood assembly according to the invention in a front view;

FIG. 10 a side view of the housing, the breathing air filter, the receptacle for the power supply unit, the viewing window, and the mounting structure according to a further, third embodiment;

FIG. 11 a longitudinal section through an assembly according to FIG. 10, adapted for cleanroom applications;

FIG. 12 a schematic view of a housing and its mounting structure for cleanroom applications in a fourth embodiment;

FIG. 13 a protective hood assembly according to a further example embodiment of the invention, inclined from behind;

FIG. 14 the arrangement according to FIG. 13 from the front;

FIG. 15 another embodiment of a protective hood assembly according to the invention, inclined from the front and from above;

FIG. 16 a view of the fan housing from above;

FIG. 17 a view of the housing according to FIG. 13 from the front;

FIG. 18 a view of another embodiment of a fan housing from the front;

FIG. 19 a view of the housing according to FIG. 16 from the front;

FIG. 20 an exploded view of the housing, fan and associated components according to FIG. 16;

FIG. 21 a cross-section through the housing and breathing air filter according to FIG. 16 at the height of the control assembly;

FIG. 22 a schematic view of a housing and its mounting structure with helmet for industrial uses, with a partially removed protective hood for the sake of clarity;

FIG. 23 a section through a further embodiment of a protective hood assembly according to the invention, similar to that of FIG. 22, with partially removed protective hood;

FIG. 24 a view through the fan housing including mounting structure of a further embodiment of a protective hood according to the invention, again adapted for cleanroom use;

FIG. 25 an inclined front and top view of the embodiment of the protective hood assembly, using the fan housing from FIG. 24;

FIG. 26 a longitudinal section through the upper section of the assembly from FIG. 25;

FIG. 27 a longitudinal section through the upper section of an assembly according to FIG. 22; and

FIG. 28 a control assembly plan.

### DETAILED DESCRIPTION OF PREFERRED EMBODIMENTS

It is worth noting here that the same parts have been given the same reference numerals or same component configurations in the embodiments described differently, yet the disclosures contained throughout the entire description can be applied analogously to the same parts with the same reference numerals or the same component configurations. The indications of position selected in the description, such as above, below, on the side etc. refer to the figure directly described and shown, and these indications of position can be applied in the same way to the new position should the position change.

As a matter of form and by way of conclusion, it is noted that, to improve understanding of the structure, elements have partially not been shown to scale and/or enlarged and/or shrunk.

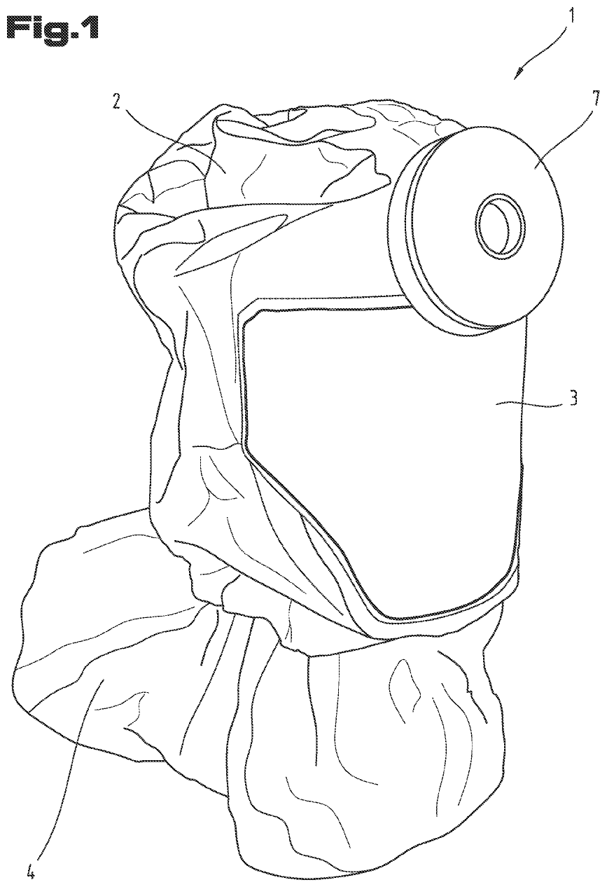

The example embodiment of a protective hood assembly according to the invention as shown in its entirety in an inclined front view in FIG. 1 has a protective hood 1 which covers the user's head and shoulders. For the barrier of the protective hood, preferably a material is used which is impervious to solid or fluid aerosols with negligible volatility and decomposition, and to germs and viruses. This can be, for example, a fleece material made of high density polyethylene (PE-D) as offered by DuPont under the brand name Tyvek®, for instance. For use in cleanrooms, a material with defined filter properties and air permeabilities approved for cleanrooms according to DIN EN ISO 14644-1 can also be used for the protective hood.

The head part 2 of the protective hood 1 has a preferably curved, transparent viewing window 3 at the front. A highly transparent polyester film is preferably used for the viewing window 3. It is preferably fastened to a rigid or flexible mounting structure 18, such as a strap running along the user's head and which is preferably elastic or adjustably pivotable by means of the hinges 19.

A shoulder part 4 is connected with the head part 2. All other example embodiments outlined below have the same functional construction with minor design-related differences.

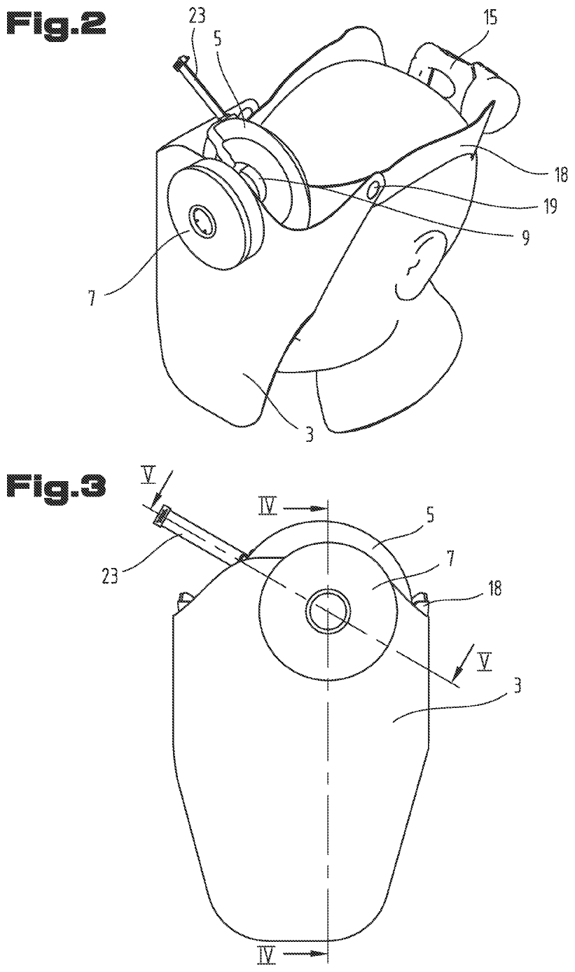

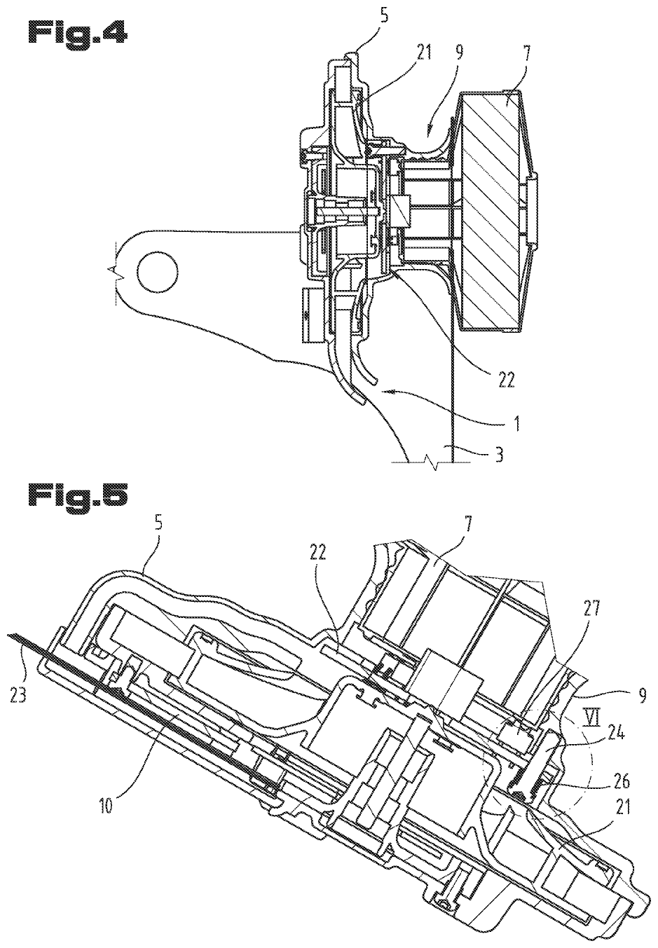

The protective hood assembly is, as shown in FIGS. 2 to 7, equipped with an active air exchange system which comprises a fan 6 received in a housing 5, as can be seen particularly well in FIGS. 4 to 7. Advantageously, the housing 5 can be produced by means of an SLS method (selective laser sintering), i.e. by means of an additive production method. The fan 6 is shown here by way of example as a radial fan with a fan wheel 21 and is provided with controls via a circuit board 10 with a control assembly. The drive for the fan 6 is advantageously integrated in the housing 5, wherein an encapsulated unit can be provided.

The air supply to the fan 6 can, if no contamination from outside is to be expected, such as when used in cleanrooms, occur via at least one opening in the protective hood 1. The fan can thereby be positioned directly at the opening or can be connected with it by at least one air duct. Advantageously, this or each opening in the protective hood 1 can be covered by a preferably unreleasably fastened filter fleece, preferably made from an FFP2 protection class material. The openings can also be used to feed breathing air via the breathing air filter 7 into the protective hood 1. The edge of each of these openings can be reinforced, for example by a plastic or metal frame.

An advantageous embodiment extends the system by a breathing air filter 7 for fresh air which is arranged in front of the fan 6 when viewed in the flow direction of the drawn in breathing air, preferably on the outside of the head part 2 of the protective hood 1. The protective hood 1 also preferably has a filter for used air. The breathing air filter 7 is typically a commercially available, preferably screwable P3 filter (in accordance with EN12941 with very high degree of separation) to protect against solid or fluid aerosols with negligible volatility and decomposition, and against germs and viruses The use of an FFP2 filter as breathing air filter 7 is also possible. A circuit board 22 for filter detection is arranged between the fan 6 and the connection 9 for the breathing air filter 7. It ensures that the fan 6 can only be put into operation after insertion of a breathing air filter 7 and preferably is also automatically started as soon as the filter 7 is inserted. The fan 6 is also deactivated again via the circuit board 22 as soon as the filter is removed.

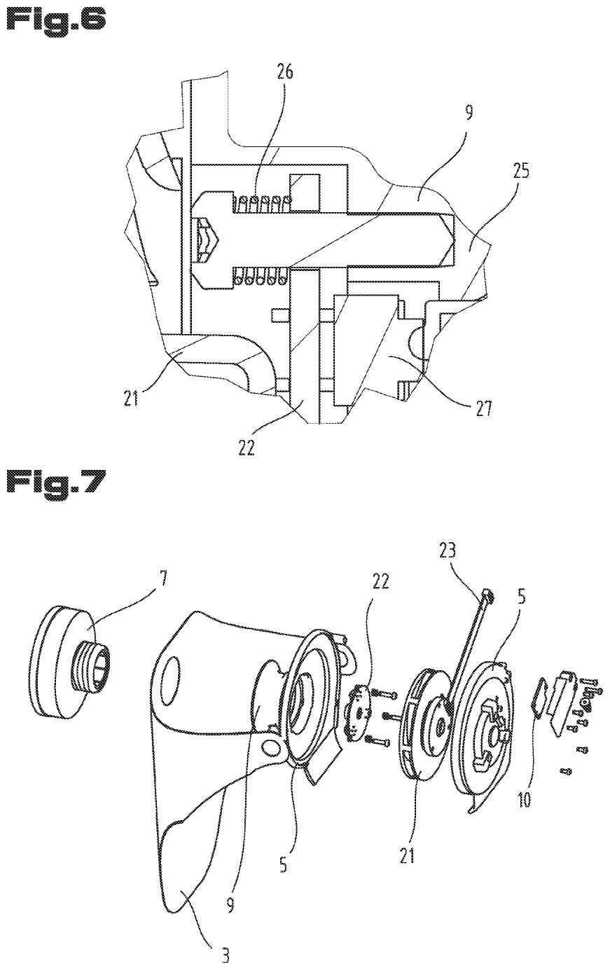

FIG. 5 and the exploded section of FIG. 6 show a preferred example embodiment for the implementation of the filter detection. The circuit board 22 intended for that is fastened in the housing 5 by means of preferably plastic screws 24, in particular in the region of the connection 9 for the filter 7, said screws being received in blind holes. By means of compression spring 26 between the head of the screw 24 and the circuit board 22, this is pushed away from the housing 5 towards the place where the inserted filter 7 is found or is intended to be found. The correctly inserted breathing air filter 7 presses on at least one limit switch 27 which is arranged on the circuit board 22 on the side opposite the compression spring 26. The circuit board 22 can thereby be pressed somewhat into the housing 5 against the effect of the compression spring 26. As long as the limit switch 27 is not activated, the fan 6 cannot be activated, wherein preferably a warning sound can be generated in addition by means of a buzzer 28 on the circuit board 22 in case the drive of the fan 6 is supplied with power while the filter 7 is not inserted.

According to the invention, the housing 5 is arranged on the inside at the front of the protective hood 1. Preferably, the housing is fastened directly to the viewing window 3 in the upper edge region where the viewing window 3 is held on the mounting structure 18 which can then also bear the weight of the housing 5 and the fan 6 as well as all components and aggregates directly connected to the housing 5 and/or the fan 6, such as the drive for the fan, a control circuit board, a directly connected power supply, etc. Preferably, a passage 20 feeds through the upper section of the viewing window 3 as is covered by the head part 2 of the protective hood 1, which is used to fasten the housing.

As can be seen particularly well in FIG. 7, at least one connection 9 for the breathing air filter 7 is provided on the housing 5 of the fan 6. A self-closing dust cap (not shown, conventional embodiment) prevents contamination of the fan 6 if the filter 7 is removed. When the protective hood assembly is ready for operation, the connection 9 forms a seal around the opening of the passage 20 with its annular end furthermost from the housing, through which passage the breathing air filter 7 can be screwed into the connection 9 or otherwise attached or inserted in a sealed manner. The breathing air filter 7 and the connection 9 are thereby pressed firmly against the viewing window 3 and connected in a sealed manner therewith, mechanically carrying the housing 5. The breathing air filter 7 is thereby arranged above the visible section of the viewing window 3, outside the protective hood assembly user's field of vision.

The used air preferably does not leave the protective hood 1 as usual via a check valve, but rather via a large filter which is preferably integrated in the rear part of the protective hood 1. It is explained in more detail in the following in conjunction with the further embodiment of a protective hood assembly.

As applies to all embodiments of the protective hood assembly, advantageously at least one discharge opening 12 for fresh air directed into the protective hood 1 is arranged on the housing 5 of the fan 6. This is preferably oriented towards the viewing window and arranged at the end of one or more air channels curved towards the viewing window 3 and when viewed cross-sectionally has a broad rectangular shape extending parallel to the viewing window 3 to generate an air curtain preventing steaming up of the viewing window 3 and to direct CO₂ away from the user and thus ensure a CO₂ concentration of less than 1 vol. % in inhaled air. It is possible for one or more silencers or similar elements to be provided.

A self-sufficient power supply unit 15 can be connected with the housing to supply power to the fan 6 and the circuit board 10 of the control assembly and/or the circuit board for filter detection. The fan 6 and the further energy consumers in the assembly are preferably powered via a commercially available lithium ion battery pack. It can advantageously be operated with different air quantities which can be calibrated from 60 to 120 l/min. The airflow remains constant during the entire duration of use of over 4 hours. The oxygen concentration of the ambient air must be more than 17 vol. %. According to EN12941, inward-bound leakage must not exceed 0.2%.

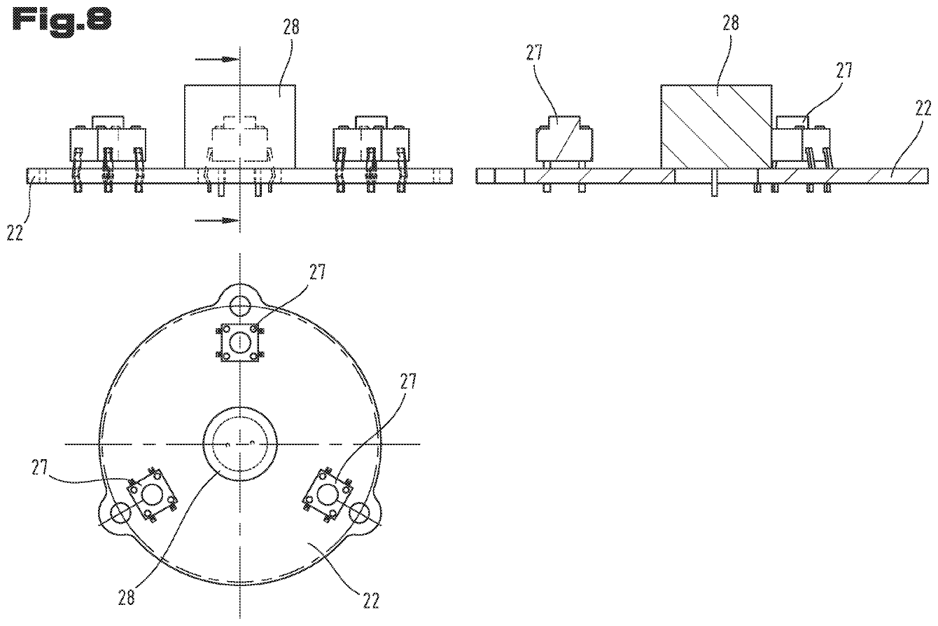

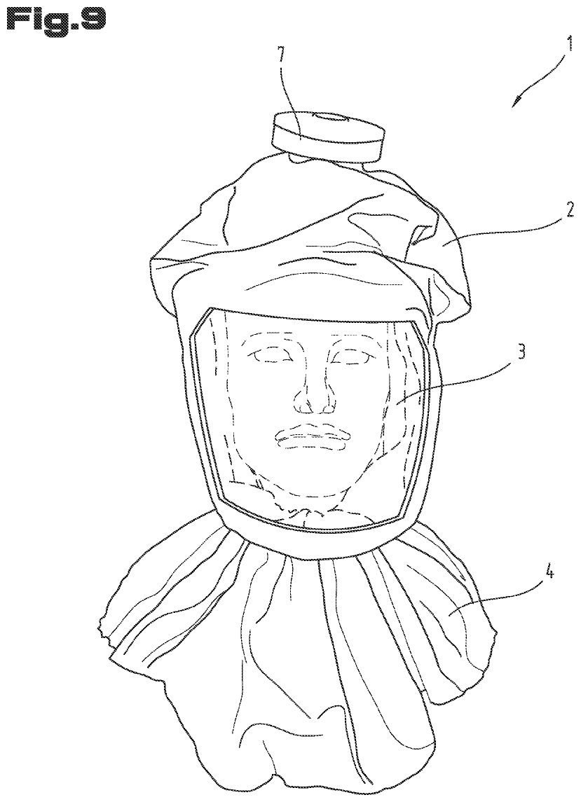

As shown by FIG. 2, the power supply unit 15 is found at a distance to the housing 5 on the rear side of the head part 2 of the protective hood 1 in the area of the back of the protective hood assembly user's head, but naturally on the inside of the head part 2. It is preferably fastened to the respectively present mounting structure 18 for the protective hood 1 and to the housing 5 and is thus positioned opposite the viewing window 3. The power supply unit 15 can be connected with the drive and the control assembly for the fan 6 via a preferably flexible electricity and control line 23—shown in FIGS. 3 and 8 in an unconnected state protruding straight out of the housing 5—wherein the connection is releasable to allow for the power supply unit to be changed, for instance.

Naturally, a power supply unit can also be worn away from the hood on the body inside or outside the protective clothing. A battery pack could therefore be attached to a belt around the middle of the body and be connected to the housing 5 via a cable. The battery pack could thereby even be worn outside the suit, wherein the energy supply is fed through a coupling incorporated into the suit in a sealed manner and transferred from there to the housing 5 via a cable on the inside of the suit and the protective hood 1.

With a breathing air filter 7 inserted which connects the housing 5 with the viewing window 3 of the protective hood 1, an assembly is provided whereby the protective hood 1, the housing 5 and the mounting structure 18 are connected with one another.

The protective hood 1 can only be used in combination with the fan 6. It is inserted into the protective hood 1 in an operable condition; the filter 7 is then screwed in and the fan 6 thus activated. The user subsequently puts the protective hood 1 together with the housing 5 with fan 6 on and the power supply unit 15 on the mounting structure 18, which also carries the viewing window 3 with the housing 5, is thereby attached and the connection cable 23 is connected with the power supply unit 15. A coat or overall can be put on over the circumferential collar or shoulder part, thus achieving a sealed system. When undressing, after removing the coat the protective hood 1 can be pulled backwards over the head on the clean shoulder part 4. The protective hood assembly 1 can thus be put on and/or taken off in as short a time as possible and is easy and fast to handle. Simple and contamination-free undressing without additional help from assistance staff is also enabled, whereupon the system can be sterilised using H2O2, for instance. When used correctly, a protection factor of over 5000 can be achieved.

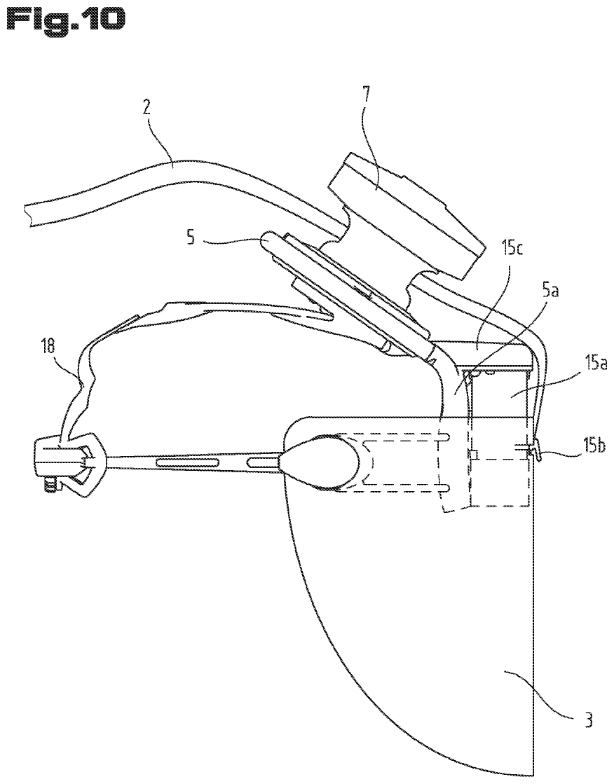

FIG. 9 shows a schematic view of a second embodiment of a protective hood assembly according to the invention in a front view. Like FIG. 1, this further example embodiment has a protective hood 1 covering the user's head and shoulders, wherein the same materials can also be used as explained in reference to the first embodiment. The head part 2 of the protective hood 1 also has a preferably curved, transparent viewing window 3 at the front, and again a shoulder piece 4 connects to the head part 2. Whilst in the first example embodiment the air filter 7 is arranged in the forehead region, typically connected with the fan 6 through the viewing window 3, the air filter 7 in the example embodiment of FIGS. 9 to 11 is positioned in the area between the forehead and apex regions of the head part 2 of the protective hood 1 such as to optimise the weight distribution with the other components of the assembly and thus achieve comfortable wearing.

FIG. 10 shows a side view of the housing 5, the breathing air filter 7, the receptacle for the power supply unit, the viewing window 3, and the mounting structure 18 of FIG. 9. The protective hood 2 material is also shown in a partial cross section. The housing 5 for the fan 6 connects with a front section 5a which comes into position in the forehead region of the user when the protective hood 2 is worn and is preferably connected with the front section of the mounting structure 18. A receiving housing 15a for the power supply unit 15, which is preferably positioned parallel thereto and parallel to the viewing window, is also configured on this front section. The viewing window 3 can be attached or hooked onto a mounting element 15b on the receiving housing 15a.

The housing 5 forms an angle of between 15 and 90° with the front section and is thus positioned in the area between the upper edge of the viewing window 3 and the apex areas of the protective hood 2. Preferably, the housing 5 and the front section 5a form an angle of approx. 45°. A crown strap of the mounting structure preferably passes from the housing 5 to the rear head area. A circuit board housing 15c contains a circuit board with a control assembly for the power supply, the drive, and the control of the fan 6 along with possible further functions described in connection with the other embodiments.

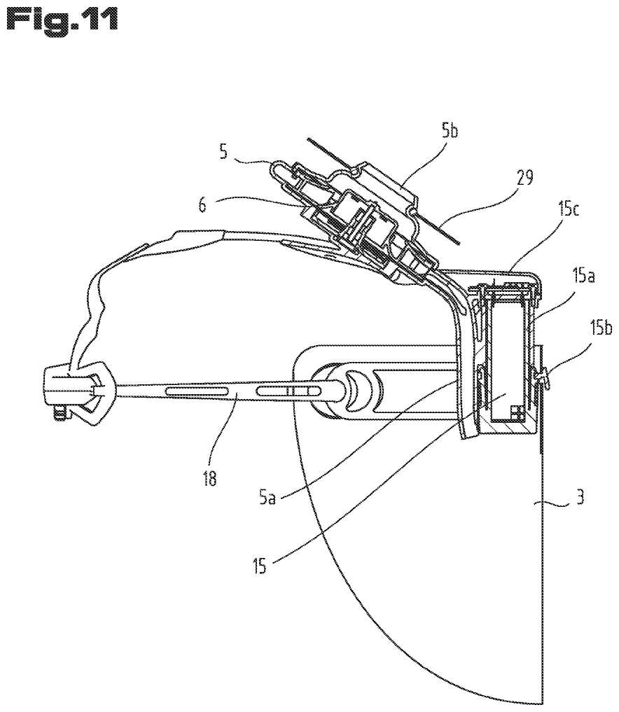

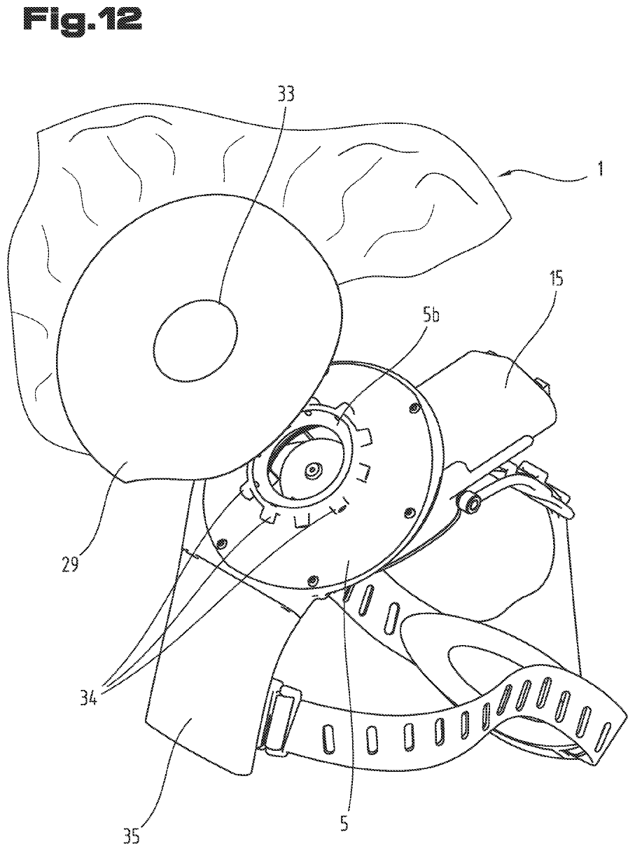

If no contamination is to be expected from the outer area of the protective hood assembly, such as in cleanrooms, an air filter 7 can be foregone and an air supply can be provided into the head part 2 of the protective hood 1 through at least one opening in the protective hood 1. Such a further embodiment of a protective hood assembly according to the invention is shown in FIG. 11 as a vertical longitudinal section through the housing 5, the fan 6, the receptacle 15a for the power supply unit 15 and the viewing window 3, and further elements described hereinafter.

The fan 6 and the housing 5 can thereby be positioned directly with an inlet port 5b on the opening, or pass through said opening. The inlet port 5b can thereby be open, but for safety reasons and for the protection of the fan 6 is preferably covered by a possibly unreleasably fastened filter fleece, preferably made from an FFP2 protection class material. The edge of these openings in the protective hood 1 can be reinforced, for example by a plastic or metal frame. Additional fixation of the head part 2 of the protective hood 1 to the inlet port 5b can also be performed by means of a plastic or rubber disc 29 with a centre hole which comes into position with a reinforcement of the edge of the centre hole in a circumferential groove of the inlet port 5b.

FIG. 12 shows a further embodiment of a protective hood assembly with yet another slightly different type of housing 5 for the fan 6. A metal ring 33 is arranged around the opening in the disc 29 or alternatively directly in the protective hood 1 which has a correspondingly unimpeded opening and is sewn into the protective hood 1, glued to the protective hood 1 or the disc 29, or soldered or otherwise connected in a manner which does not jeopardise the impermeability of the assembly. Magnets 32 are arranged in the housing 5 around the inlet port 5b which protrudes with its outer edge through the protective hood 1 which fix the metal ring 33 and thus the protective hood 1 on the housing 5. A discharge passage 35 for the propelled breathing air which is preferably fashioned in a single piece together with the housing 5 leads from the housing 5 directly to the front side of the protective hood 1. Furthermore, the positioning of the power supply unit 15 behind the housing 5 when viewed in the longitudinal direction of the assembly in the user's upper head or crown region, which ensures better balance of the overall assembly, should be noted.

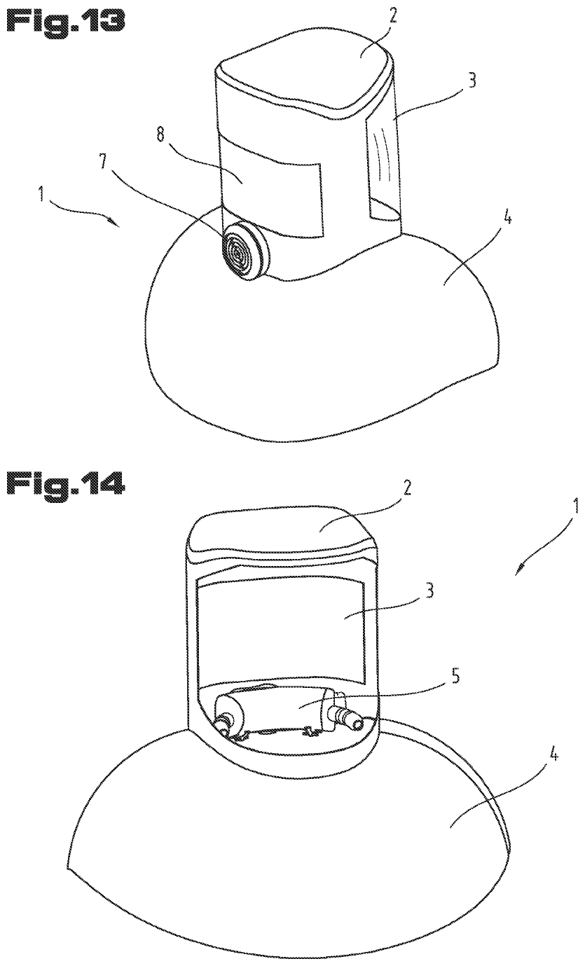

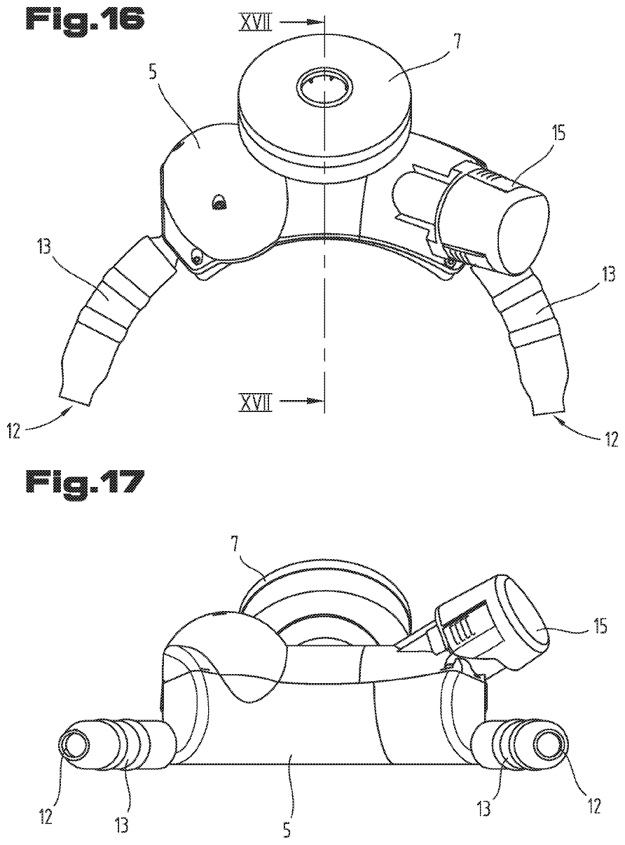

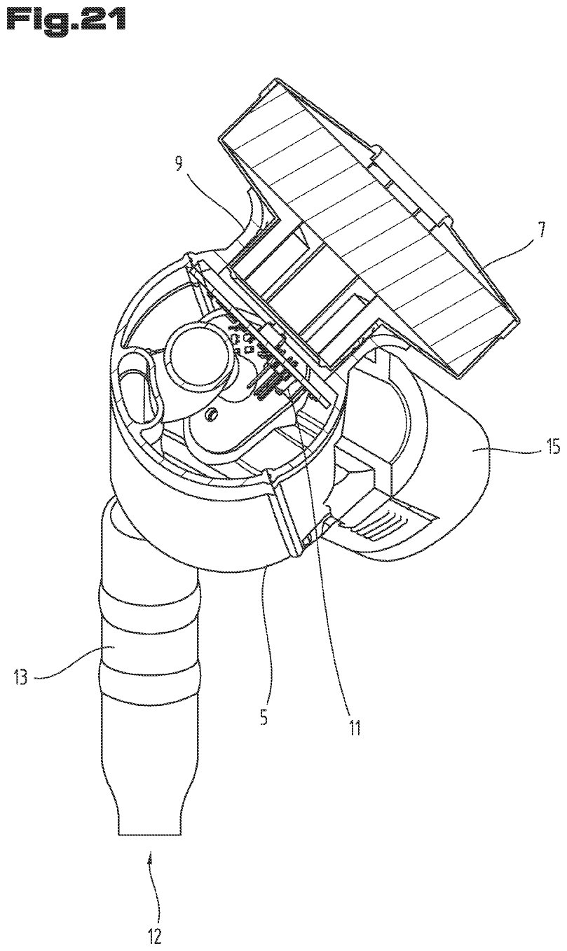

The further example embodiment of a protective hood assembly according to the invention shown in FIGS. 13 to 21 also has a protective hood 1 covering the user's head and shoulders. The head part 2 here is preferably configured to be self-supporting and has a preferably curved, transparent viewing window 3 at the front. A shoulder part 4 is connected with the head part 2. The explanations of the materials used in the first example embodiment apply here in the same way.

The protective hood assembly is also equipped with an active air exchange system here which comprises a fan 6 which is received in a housing 5. Furthermore, the system also again comprises a breathing air filter 7 for fresh air and a filter in the protective hood 1 for used air, placed in front of the fan and preferably arranged on the outside of the head part 2 of the protective hood 1.

The used air does not leave the protective hood 1 as usual via a check valve, but rather via a large filter which is preferably integrated in the rear part of the protective hood 1 and preferably consists of a filter fleece 8, which forms part of the rear side of the head part 2 of the protective hood 1. This fleece 8 can have the same properties as the breathing air filter 7 at the air inlet. Preferably, a material of at least the FFP2 protection class is provided for. Where necessary, the entire protective hood can consist of a filter fleece, preferably also of a material of at least the FFP2 protection class. For use mainly in aseptic cleanrooms, conventional cleanroom fabrics can also be used. Such a solution can also be provided for all other protective hood assemblies according to the invention.

In order to ensure this filtering, the hood is preferably sealed at the neck. Protection of the environment is thereby guaranteed even if the user should already be infected with a virus. The same type of filtering of used air which is discharged from the inside of the protective hood is preferably used in the two example embodiments of a protective hood assembly described in detail above and as shown by way of example in FIGS. 1 to 12.

The shoulder part 4 can also be worn outside an overall or coat with an enlarged chest and back flap. The chest and back flap is fastened across the chest by means of sewn on straps. The protective hood 1 is thereby sealed at the neck by means of an adjustable elastic inner collar strap. Thus, no unfiltered exhaled air can escape beneath the shoulder part 4 or the chest and back flap, rather it can only escape having been filtered through the filter fleece 8 or other filter means for exhaled air.

The construction of the housing 5, fan 6 and breathing air filter 7 corresponds substantially to that of the first example embodiment. The arrangement of the fan 6 or the housing 5 does, however, vary considerably from the protective hood assembly described above. When in use, the fan 6 is worn at the neck within the protective hood 1 such that it cannot be contaminated during use.

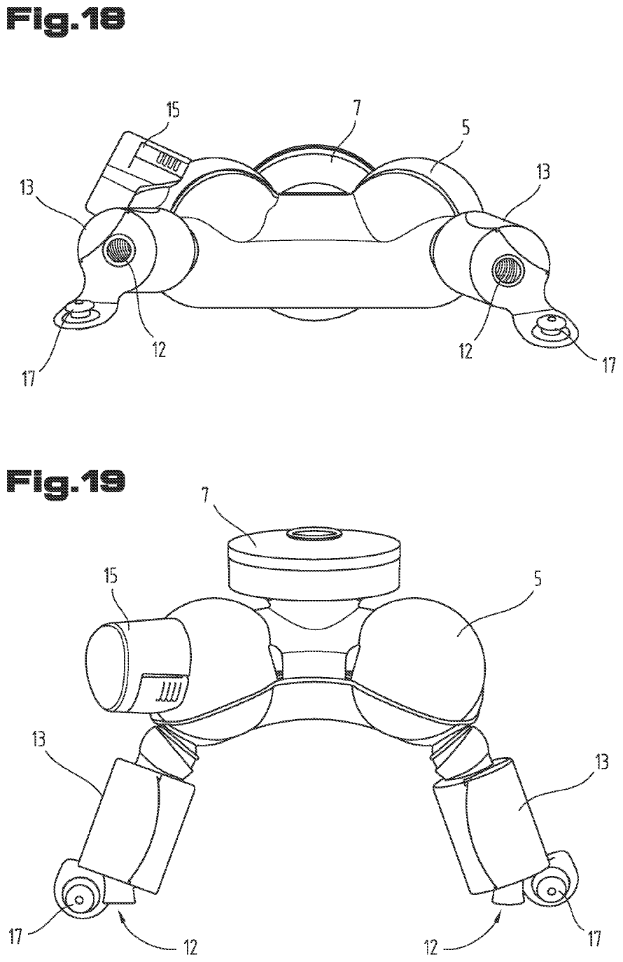

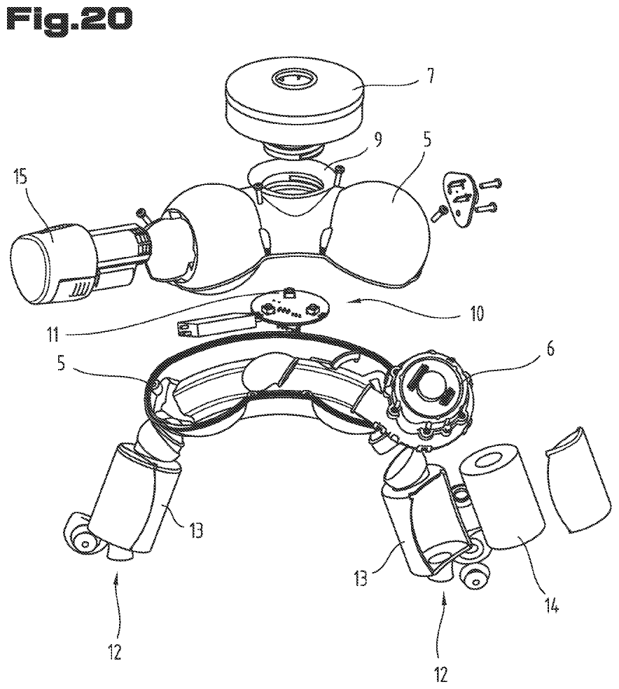

Advantageously, at least one discharge opening 12 for fresh air directed into the inside of the protective hood 1, preferably towards the front of the head part 2 of the protective hood 1, is arranged on the housing 5 of the fan 6. According to a particularly preferred embodiment, air ducts 13 which extend on the sides of the head part 2 in a forwards direction past the protective hood 1 user's head in the direction of the viewing window 3 are connected to the fan 5. Discharge gas openings 12 are then found at the extremity of the ducts 13. FIG. 19 shows an exploded view of an advantageous embodiment according to which silencers 14 are inserted in the air duct tubes 13. In these embodiments with air duct tubes 13, the breathing air flows past on both sides of the protective hood assembly 1 user's head, thereby not irritating the eyes and preventing the viewing window from steaming up due to this direct air guidance. Moreover, optical aids such as glasses and contact lenses can be worn without problems.

The drive for the fan 6 is advantageously integrated in the housing 5, wherein an encapsulated unit can be provided. A self-sufficient power supply unit 15 can be directly coupled with the housing to supply power to the fan 6 and the circuit board 10 for the control assembly. For this purpose, a receptacle is provided in the housing 5 into which the power supply unit 15 can be inserted, whereby the power supply unit 15 preferably creates a sealed closure of the receptacle in the housing 5, possibly using seal rings or similar measures. Here again it is also possible to wear a power supply unit on the body arranged remotely from the hood either within or outside the protective clothing, for example as a belt battery pack inside or outside the protective clothing. Energy supply can also be provided externally via a coupling incorporated into the suit in a sealed manner.

The fan 6 or the power supply unit 15 can also be provided with a low voltage output for a preferably electrochemical device for generating ozone, with such a device arranged separately or integrated into the housing 5 of the fan 6.

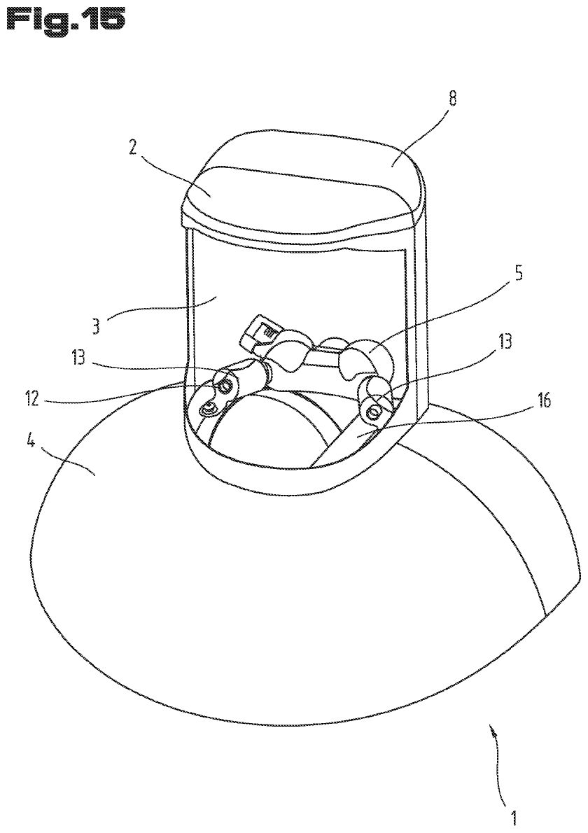

As can be seen in FIG. 15, the protective hood assembly according to the invention comprises a mounting frame or a breastplate 16 as an assembly with at least a carrying strap which can be used beneath the protective hood. By means of conventional connecting means, such as press studs 17, which can be arranged in the area of the air duct tubes 13, the housing 5 is releasably connectable with the breastplate 16. With a breathing air filter 7 inserted which connects the housing 5 with the head part 2 of the protective hood 1, an assembly is provided whereby the protective hood 1, the housing 5, possibly with air duct tubes 13, and the breastplate 16 are connected with one another.

The protective hood 1 can again only be used in combination with the fan 6. After the user has put the protective hood 1 including housing 5 with fan 6 on, the housing 5 is fastened to the breastplate 16, following which a coat or overall can again be put on over the circumferential collar or shoulder part, thus achieving a sealed system. When undressing, the explanations regarding the initially described protective hood assembly again apply.

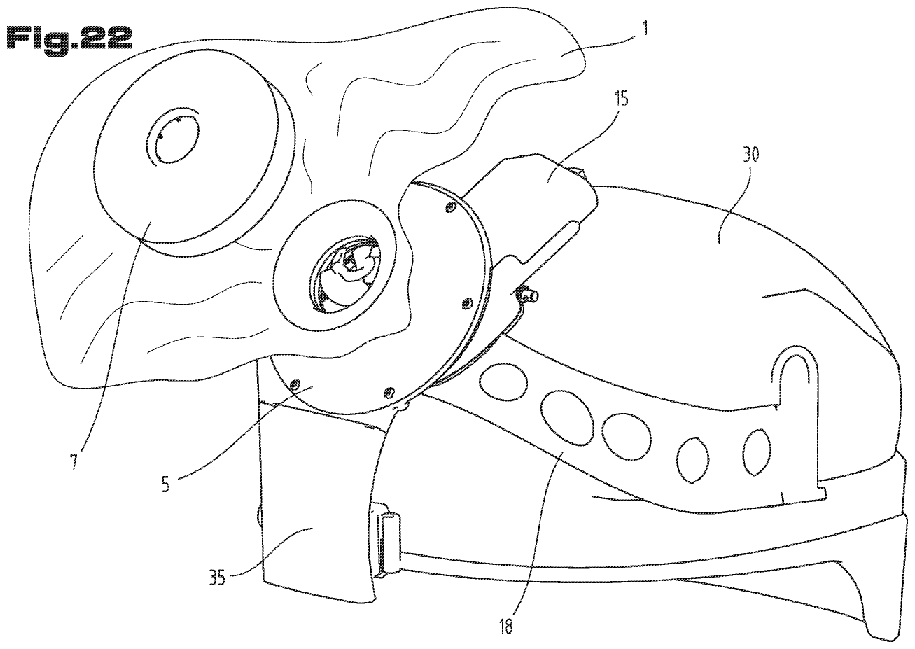

A further embodiment of the invention according to FIG. 22 provides for a helmet 30 to be located within the protective hood to which the mounting structure 18 for the housing 5 with the fan 6, the power supply unit 15, and of course the protective hood 1 with its viewing window 3 (not shown here) are themselves attached.

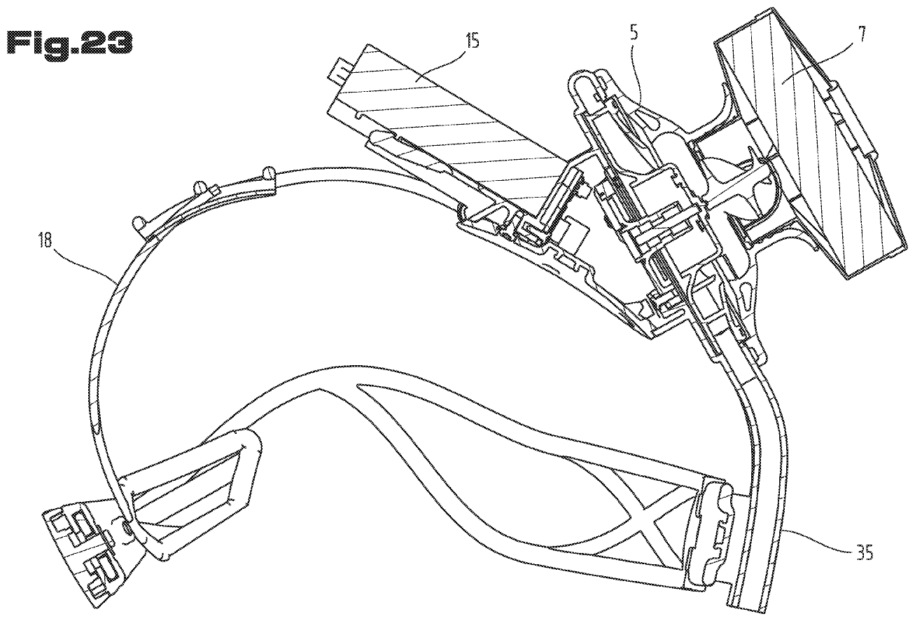

The basic embodiment of housing 5 with discharge passage 35 leading forwards and downwards into the area of the viewing window 3 and with the power supply unit 15 positioned in the upper head area is shown in longitudinal section in FIG. 23. The embodiment shown here is provided with a typical mounting structure 18, comparable with a cycling helmet, and configured for use in contaminated environments through the arrangement of a breathing air filter 7.

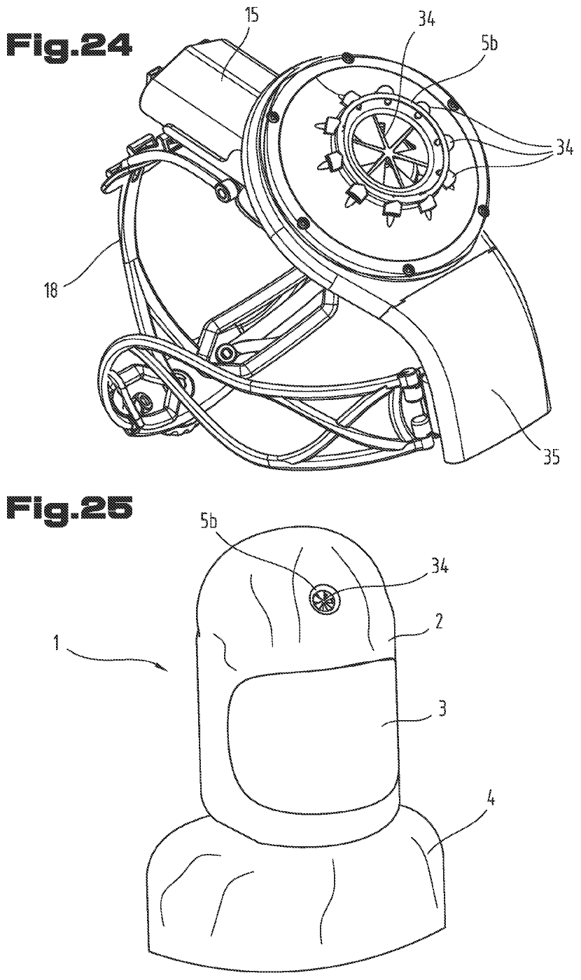

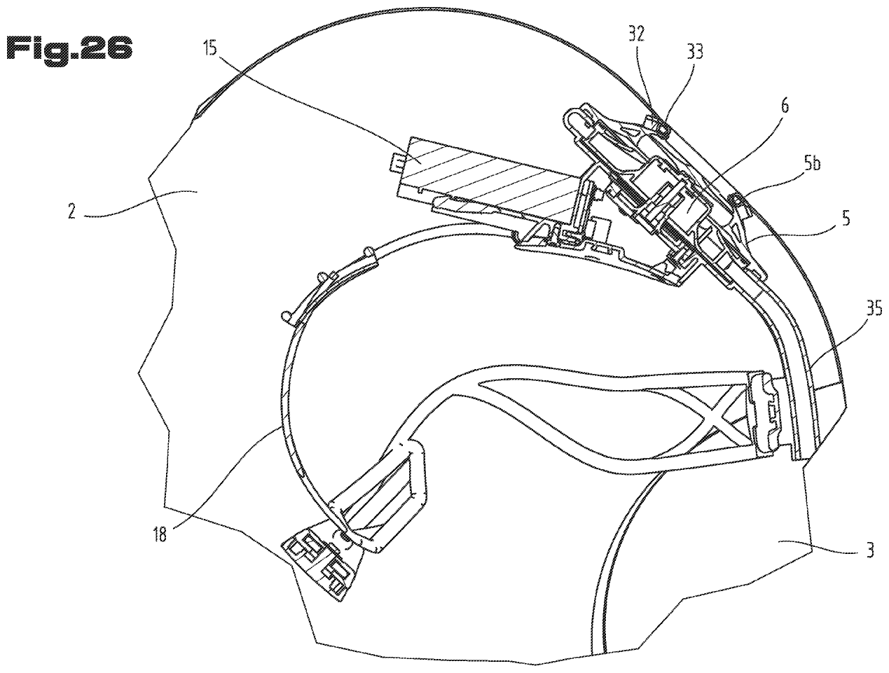

An equivalent embodiment, but for use in cleanrooms, is shown in FIG. 24, wherein the opening of the inlet port 5b protruding through the passage opening of the protective hood 1 is protected by a mesh cover 34 from larger contaminations or fragments entering the fan 6. The outermost edge of the inlet port 5b and the mesh cover 34 can also be seen in FIG. 25 which shows the cleanroom protective hood assembly in its entirety, as well as in longitudinal section in FIG. 26.

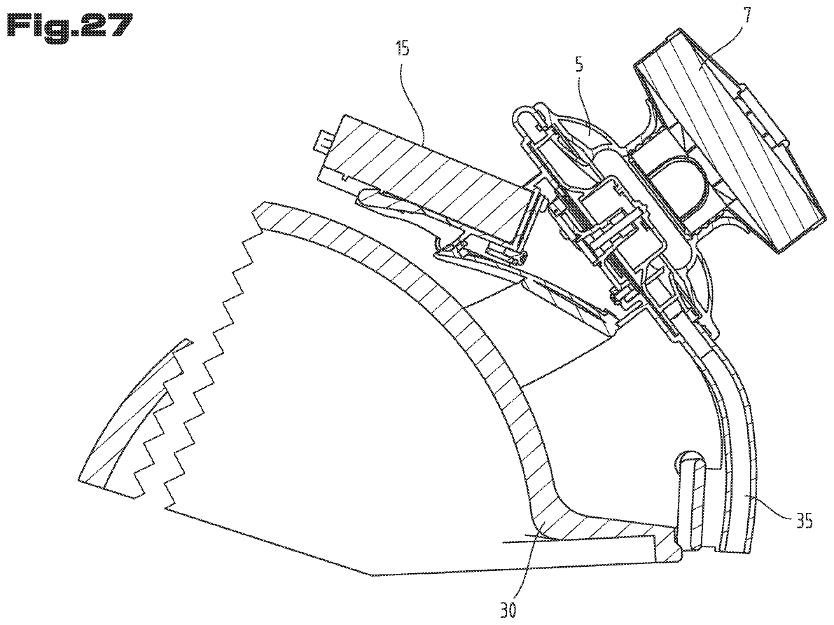

By way of comparison, FIG. 27 shows a comparable section through a protective hood assembly (without the actual protective hood itself) with helmet 30, configured for contaminated environments.

A further aspect of the invention is a control assembly which ensures the safe supply of physiologically correctly composed breathing air to the user, in particular if the user's exposure and thus their oxygen requirements, as well as the CO₂ in the exhaled air, change rapidly and/or severely.

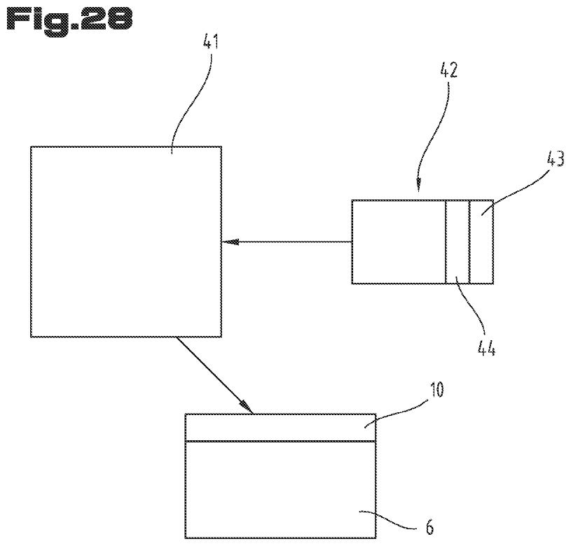

As shown schematically in FIG. 28, the control assembly 10 is thereby equipped with or connected to a sensor unit 42 which emits a signal representing at least the user's breathing rate. In an evaluation unit 41 which can possibly also be implemented by a hardware or software module of control assembly 10, there is at least one input for the signal of the sensor unit 41 and an output for the fan 6 which is fed into its control unit 9 and for that purpose is positioned on an input for the control signal of the evaluation unit 41. A proportional control signal is generated for the fan 6 in the evaluation unit 41 on the basis of the breathing rate such that the air quantity propelled by means of the fan is proportional to the breathing rate. An increasing CO₂ concentration in the air within the protective hood 1 at increased breathing rate can be compensated by an increase in the airflow and be maintained below the level which would be dangerous for the user. The CO₂ concentration of the breathing air must under no circumstances exceed an average proportion of 1 vol. %.

The air quantity is preferably within a range of between 40 l/m and 100 l/min and the fan 6 is preferably configured such that it is precisely adjustable up to the two limits, but can also ensure higher loads when propelling air quantities in the upper limit range for longer periods without overloading.

A simple and reliable detection of breathing rate can be performed by monitoring pressure inside the protective hood 1, preferably in the area close to the user's mouth and nose. For this purpose, the sensor unit 42 is equipped with at least one pressure sensor 43 for the air inside the protective hood 1.

A further embodiment of a control assembly according to the invention provides that the sensor unit 42 has a CO₂ sensor 44 and in that the evaluation unit is configured such that if a threshold value for the CO₂ concentration within the protective hood 1 is exceeded, the fan is sped up and/or a warning signal is generated. A safety function is thus implemented in case the rapid adjustment adapted to the user's breathing rate via pressure or breathing rate should fail or be disrupted.

In order to avoid overloading the control circuit 6 for the fan and thus reduce the load of the fan 6, the evaluation unit 41 is preferably configured such that the control signal for the fan 6 is only generated after a predeterminable number of shortened or extended breathing cycles.

According to a preferred embodiment, a further safety level is provided in that a safety algorithm is implemented in the control unit 9 or the evaluation unit 41 which initiates at least a predeterminable action in the event of a non-detectable and/or absent pressure change, and in particular initiates a warning signal and/or switches the fan to a safety mode. Preferably, the safety algorithm is configured such that in the safety mode the fan is controlled to propel an air quantity of 80 l/min.

The example embodiments show possible embodiment variations, although it is to be noted here that the invention is not limited to the specifically represented embodiment variations of the same, but rather various combinations of the individual embodiment variations as well as individual features thereof with one another are possible, and that given the technical teachings provided by the present invention this variation possibility is within the ability of the skilled person in this technical field.

List of reference numerals

| | |
|---|---|
| 1 | Protective hood |
| 2 | Head part |
| 3 | Viewing window |
| 4 | Shoulder part |
| 5 | Housing |
| 5a | Front section |
| 5b | Inlet port |
| 6 | Fan |
| 7 | Breathing air filter |
| 8 | Filter fleece |
| 9 | Connection |
| 10 | Control assembly circuit board |
| 11 | Switch |
| 12 | Discharge opening |
| 13 | Air duct tube |
| 14 | Silencer |
| 15 | Power supply unit |
| 15a | Receiving housing |
| 15b | Mounting element |
| 15c | Circuit board housing |
| 16 | Mounting frame |
| 17 | Press studs |
| 18 | Mounting structure |
| 19 | Hinge |
| 20 | Passage |
| 21 | Fan wheel |
| 22 | Filter recognition circuit board |
| 23 | Connection cable |
| 24 | Screw |
| 25 | Blind hole |
| 26 | Compression spring |
| 27 | Limit switch |
| 28 | Buzzer |
| 29 | Plastic disc |
| 30 | Helmet |
| 31 | Air inlet opening |
| 32 | Magnet |
| 33 | Metal ring |
| 34 | Mesh cover |
| 35 | Discharge passage |

1. A protective hood assembly, comprising a protective hood (1) which covers the user's head and shoulders made from flexible, pliable material and with a viewing window (3), a mounting structure (18) for the protective hood (1), an active air exchange system with a fan (6) with corresponding control assembly, a housing (5) for the fan (6) arranged within and separate from the protective hood (1), which is attached to the mounting structure (18) within the protective hood (1), and a filter (8) for the used air integrated in the protective hood (1), further comprising an air inlet opening (31) allowing unimpeded flow-through and leading to the fan (6) in the protective hood (1), and further comprising an inlet port (5b) emanating from the housing (5), routed in a sealed manner through the air inlet opening (31) of the protective hood (1) on the outer side thereof, forming a releasable connection between the mounting structure (18) and the protective hood (1), wherein the air inlet opening (31) and/or the inlet port (5b) is/are covered by a cleanroom fabric or filter fleece, preferably by an FFP2 protection class material, or by a breathing air filter (7) for fresh air placed on the inlet port (5b) on the outside of the protective hood (1) in front of the fan (6), or by a mesh cover (34).

2-3. (canceled)

4. The assembly according to claim 1, wherein the housing (5) is arranged in the region between the crown and the front of the protective hood (1) and is preferably connected with the mounting structure (18) in this region.

5. The assembly according to claim 1, wherein the inlet port (5b) preferably passes through an upper section of the viewing window (3) covered by the protective hood (1) and wherein the breathing air filter (7) is preferably arranged above the visible area of the viewing window (3).

6. The assembly according to claim 1, wherein the housing (5) of the fan (6) and the air inlet opening (31) are arranged on the rear side of the protective hood (1), preferably at the level of the neck section of the protective hood (1), wherein a possible breathing air filter (7) is preferably also arranged on the rear side of the protective hood (1).

7. The assembly according to claim 6, wherein a mounting frame (16) or an assembly with at least one carrying strap beneath the protective hood (1) is deployable and releasably connectable with the housing (5), or wherein the housing (5) is releasably connectable with the mounting structure (18).

8. The assembly according to claim 1, wherein the mounting structure (18) and/or the housing (5) is/are mounted on a helmet (30) positioned within the protective hood (1).

9. The assembly according to claim 1, wherein the drive of the fan (6) is integrated in the housing thereof and wherein preferably a self-sufficient power supply unit (15) can be coupled to the housing (5).

10. The assembly according to claim 9, wherein the power supply unit (15) is positioned at a distance from the housing (5) on the inner side of the protective hood (1), preferably on a carrying strap or browband, and preferably on the rear side opposite the viewing window (3), and is connected with the drive and the control assembly for the fan (6) via a preferably flexible electricity and control line (23).

11. The assembly according to claim 10, wherein the housing (5) has a receptacle for the self-sufficient power supply unit (15), preferably in the longitudinal central plane of the mounting structure (18), which can be directly coupled with the housing (5), preferably by way of insertion into the housing (5).

12. The assembly according to claim 1, wherein at least a partial area of the protective hood (1) is made of a filter fleece (8), preferably an FFP2 filter fleece, which represents the filter for the used air, wherein the partial area is preferably arranged on the rear side of the protective hood (1), or wherein the entire protective hood (1) is made of a cleanroom fabric, preferably according to DIN EN ISO 14644-1, or a filter fleece, preferably an FFP2 filter material.

13. The assembly according to claim 1, further comprising a sensor unit (42), which emits at least one signal representing the user's breathing rate, an evaluation unit (41) with at least one input for the signal from the sensor unit (42) and an output for a control signal for the fan, a control unit (9) for the fan (6) with an input for the control signal from the evaluation unit (41), wherein the evaluation unit is configured so as to generate a control signal proportional to the breathing rate for the fan (6) such that the air quantity propelled by means of the fan (6) is proportional to the breathing rate.

14. The assembly according to claim 13, wherein the air quantity is in a range of between 40 l/min and 100 l/min.

15. The assembly according to claim 13, wherein the sensor unit (42) has a pressure sensor (43) for the air within the protective hood (1).

16. The assembly according to claim 13, wherein the sensor unit (42) has a CO₂ sensor (44) and wherein the evaluation unit is configured such that if a threshold value for the CO₂ concentration within the protective hood (1) is exceeded, the fan (6) is sped up and/or a warning signal is generated.

17. The assembly according to claim 13, wherein the evaluation unit (41) is configured such that the control signal for the fan (6) is only generated after a predeterminable number of shortened or extended breathing cycles.

18. The assembly according to claim 13, wherein a safety algorithm is implemented in the unit which initiates at least a predeterminable action in the event of a non-detectable and/or absent pressure change, and in particular initiates a warning signal and/or switches the fan to a safety mode.

19. The assembly according to claim 18, wherein in safety mode the fan (6) propels an air quantity of 80 l/min.

20. The assembly according to claim 13, wherein the fan (6) is connected with a control assembly (10) which initiates operation of the fan (6) after placement of the breathing air filter (7) or the mesh cover (34) in the inlet port (5b), wherein the control assembly (10) is preferably integrated in the housing (5) of the fan (6).
